(19) United States
(12) Patent Application Publication
(10) Pub. No.: US 2007/0206728 A1
(43) Pub. Date: Sep. 6, 2007

(54) computer home/office integrated police and fire safety system

(75) Inventor: John Volpentesta, Marengo, IL (US)

Correspondence Address: John Volpentesta, 310 S. State St., Marengo, IL, 60152, US

(73) Assignee: Volpentesta, Marengo, IL (US)

(21) Appl. No.: 11/308,089

(22) Filed: Mar. 6, 2006

(51) Int. Cl. H04M 11/04

(52) U.S. Cl. 379/37

(57) ABSTRACT

A computer-integrated fire safety system, along with software, that would contact police and/or fire department in the event of a fire and/or toxic fumes at its location.

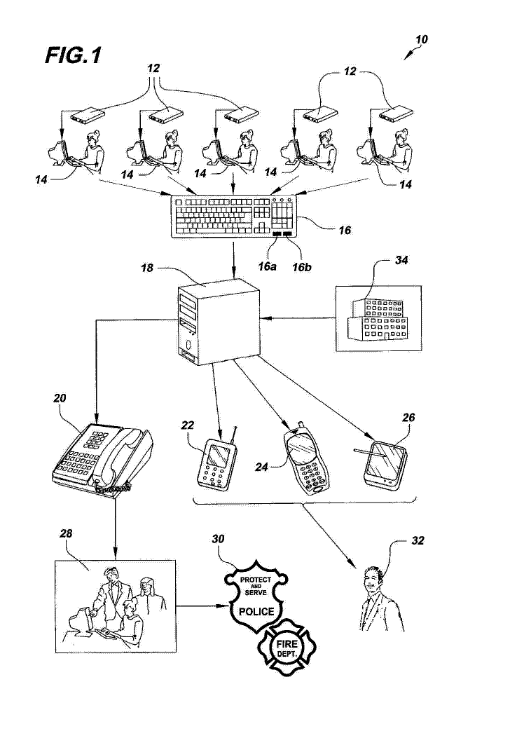

The invention relates to a computer-integrated fire safety system, along with software, that would contact police and/or the fire department in the event of a fire and/or toxic fumes at its location. There would also be panic buttons located for both police and fire department on the keyboard. Once activated, it would dispatch biz intelligent software information of an emergency at that location. This software would inform the authorities of the computer's exact location in the home or office.

This application would work best in an office where there are multiple computers, since the system would be able to direct help right to the source.

This computer fire safety system could be integrated with any building fire safety system. Alternatively, this software could also contact the owner or management of the location that is being threatened.

What is claimed is:

1. A computer-integrated fire safety system. Along with software that would contact police and/or the fire department in the event of a fire and/or toxic fumes at its location.
